(19) United States
(12) Patent Application Publication
(10) Pub. No.: US 2026/0143055 A1
(43) Pub. Date: May 21, 2026

(54) QUICK-TO-DISMOUNT HOLDER

(71) Applicant: Dongguan Jinchi Electronic Technology Co., Ltd., Dongguan (CN)

(72) Inventor: Pengcheng DU, Dongguan (CN)

(21) Appl. No.: 19/187,686

(22) Filed: Apr. 23, 2025

(30) Foreign Application Priority Data
Nov. 15, 2024 (CN) 202422793102.5

(51) Int. Cl. H04M 1/04; F16M 11/04; F16M 11/10; H04M 1/02

(52) U.S. Cl. CPC H04M 1/04; F16M 11/041; F16M 11/105; H04M 1/0203

(57) ABSTRACT

The present disclosure relates to the technical field of mobile phone holders, and in particular to a quick-to-dismount holder. The holder includes a mobile phone housing or a power bank housing or an adhesive connecting accessory, where a rear end of the mobile phone housing or the power bank housing or the adhesive connecting accessory is provided with a groove, a connecting member is fixedly mounted in the groove, and a rear end of the connecting member is provided with a detachable structure. The detachable structure includes a surface cover and a bottom cover, a right arm and a left arm are arranged on the surface cover, a compression spring is arranged between the left arm and the right arm, a retaining latch groove is formed in a middle of the connecting member, and the retaining latch groove is annular.

### CROSS-REFERENCE TO RELATED APPLICATIONS

The present application claims priority to Chinese Patent Application No. 202422793102.5, filed on November 15, 2024, the entire disclosure of which is incorporated herein by reference.

### TECHNICAL FIELD

The present disclosure relates to the technical field of mobile phone holders, and in particular to a quick-to-dismount holder.

### BACKGROUND

When a mobile phone holder is used, only a mobile phone can be clamped, and other articles cannot be clamped. To remove the mobile phone, the holder needs to be opened manually, such that the mobile phone can be taken down from the holder. Since the holder is attached to a side surface of the mobile phone, it is difficult to apply force to the holder duration operation, resulting in inconvenient and cumbersome removal process.

Therefore, the present disclosure provides a quick-to-dismount holder.

### SUMMARY

An objective of the present disclosure is to provide a quick-to-dismount holder, so as to solve the problems mentioned in the background art.

To achieve the above objective, the present disclosure provides the technical solutions as follows:

A quick-to-dismount holder, including a mobile phone housing or a power bank housing or an adhesive connecting accessory, where a rear end of the mobile phone housing or the power bank housing or the adhesive connecting accessory is provided with a groove, a connecting member is fixedly mounted in the groove, and a rear end of the connecting member is provided with a detachable structure.

The detachable structure includes a surface cover and a bottom cover, where a right arm and a left arm are arranged on the surface cover, and a compression spring is arranged between the left arm and the right arm. A retaining latch groove is formed in a middle of the connecting member, the retaining latch groove is annular, retaining latches are arranged at opposite ends of the right arm and the left arm, and the retaining latches are connected to the retaining latch groove.

A rotary positioning mechanism is arranged between the connecting member and the surface cover.

The rotary positioning mechanism includes ball detent springs, where the ball detent springs are fixedly arranged on the surface cover, positioning grooves are formed on a circumference of the connecting member, and the ball detent springs are connected to the positioning grooves.

In a preferred embodiment of the present disclosure, the rear end of the mobile phone housing or the power bank housing or the adhesive connecting accessory is flush with the rear end of the connecting member, a front end of the surface cover is provided with mounting grooves, and the ball detent springs are fixedly mounted inside the mounting grooves.

In a preferred embodiment of the present disclosure, guide grooves are opened in two sides of a rear end of the surface cover, the right arm is arranged on an inner wall of the guide groove on a right side, the left arm is arranged on an inner wall of the guide groove on a left side, and the retaining latches extend into a through hole in a center of the surface cover.

In a preferred embodiment of the present disclosure, a side, closest to the compression spring, of the right arm is provided with a spring placing groove, a spring positioning pin is arranged on an inner wall of the spring placing groove, the spring positioning pin is connected to the compression spring, a button is arranged on a side, farthest away from the compression spring, of the right arm, and the left arm and the right arm have the same structure.

In a preferred embodiment of the present disclosure, a circumference of the bottom cover is fixedly connected to the surface cover through screws.

In a preferred embodiment of the present disclosure, each ball detent spring is formed by a cylindrical housing, a spring and a detent ball, the spring and the detent ball are mounted inside the cylindrical housing, one end of the spring is connected to the detent ball, the other end of the spring is connected to a bottom of an inner wall of the cylindrical housing, and the spring is in a compressed state.

In a preferred embodiment of the present disclosure, a 3M adhesive layer is mounted on the connecting member, and the 3M adhesive layer is stuck to the mobile phone housing or the power bank housing or the adhesive connecting accessory.

Additional aspects and advantages of the present disclosure will be set forth partially in the following description, which will become obvious in the following description, or may be learned by practice of the present disclosure.

The buttons are pressed to make the compression spring be compressed, such that the retaining latches of the right arm and the left arm are released to move inward together to reach retreat positions, and then, an accessory is taken out, thereby realizing a quick taking function with one press.

The springs are arranged inside the ball detent springs, such that the detent balls at heads keep an upward thrust force. The ball detent springs provide an upward force to ensure that the retaining latches of the right arm and the left arm are in tight fit with the retaining latch groove in the connecting member.

The detent balls at the heads of the ball detent springs correspond to the positioning grooves, such that the connecting member can realize 360-degree rotation, and an angle can be kept.

### BRIEF DESCRIPTION OF THE DRAWINGS

The above-mentioned and/or attached aspects and advantages of the present disclosure will become apparent and easy to understand from the description of the examples with reference to the following accompanying drawings, in which:

FIG. 1 is a schematic exploded diagram of a quick-to-dismount holder.

FIG. 2 is a perspective view of a quick-to-dismount holder.

FIG. 3 is a first perspective view of connection between a connecting member and a surface cover in a quick-to-dismount holder.

FIG. 4 is a second perspective view of connection between a connecting member and a surface cover in a quick-to-dismount holder.

FIG. 5 is a first sectional view of connection between a connecting member and a surface cover in a quick-to-dismount holder.

FIG. 6 is a second sectional view of connection between a connecting member and a surface cover in a quick-to-dismount holder.

FIG. 7 is a third sectional view of connection between a connecting member and a surface cover in a quick-to-dismount holder.

FIG. 8 is a sectional view of a ball detent spring in a quick-to-dismount holder.

FIG. 9 is a schematic diagram of a connection structure of a 3M adhesive layer and a connecting member in a quick-to-dismount holder.

FIG. 10 is a first schematic diagram of a connection structure of a power bank housing and a surface cover in a quick-to-dismount holder.

FIG. 11 is a second schematic diagram of a connection structure of a power bank housing and a surface cover in a quick-to-dismount holder.

In the figures: 1. mobile phone housing; 2. connecting member; 21. positioning groove; 22. retaining latch groove; 3. surface cover; 31. guide groove; 32. mounting groove; 4. ball detent spring; 5. right arm; 51. spring placing groove; 52. spring positioning pin; 53. button; 54. retaining latch; 6. left arm; 7. compression spring; 8. bottom cover; 9. screw; 10. 3M adhesive layer; and 11. power bank housing.

### DETAILED DESCRIPTIONS OF THE EMBODIMENTS

Examples of the present disclosure are described in detail below, instances of the examples are shown in the accompanying drawings, throughout which identical or similar reference numerals denote identical or similar elements or elements having identical or similar functions. The examples described below with reference to the accompanying drawings are exemplary and intended to explain the present disclosure, instead of being construed as limiting the present disclosure.

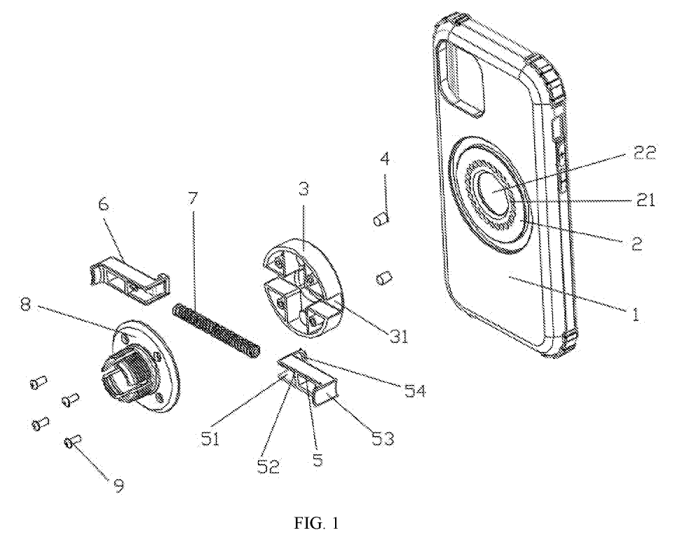

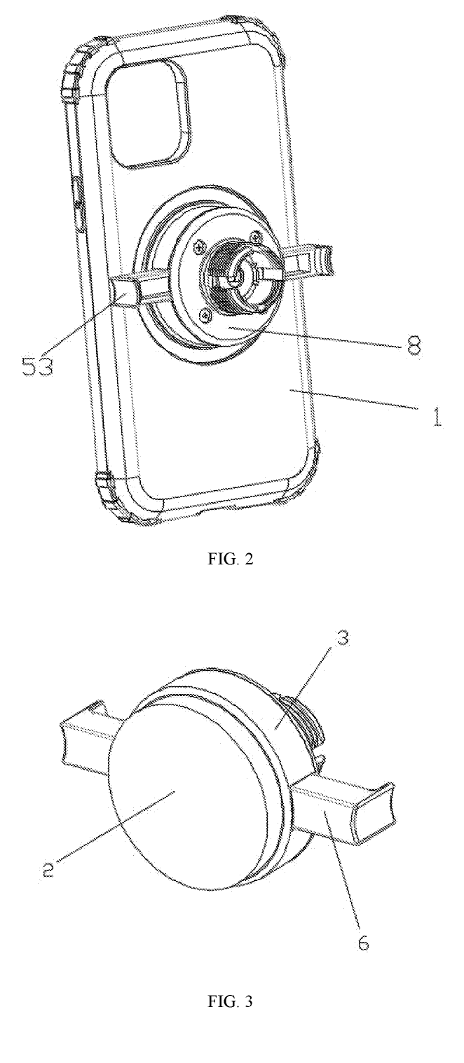

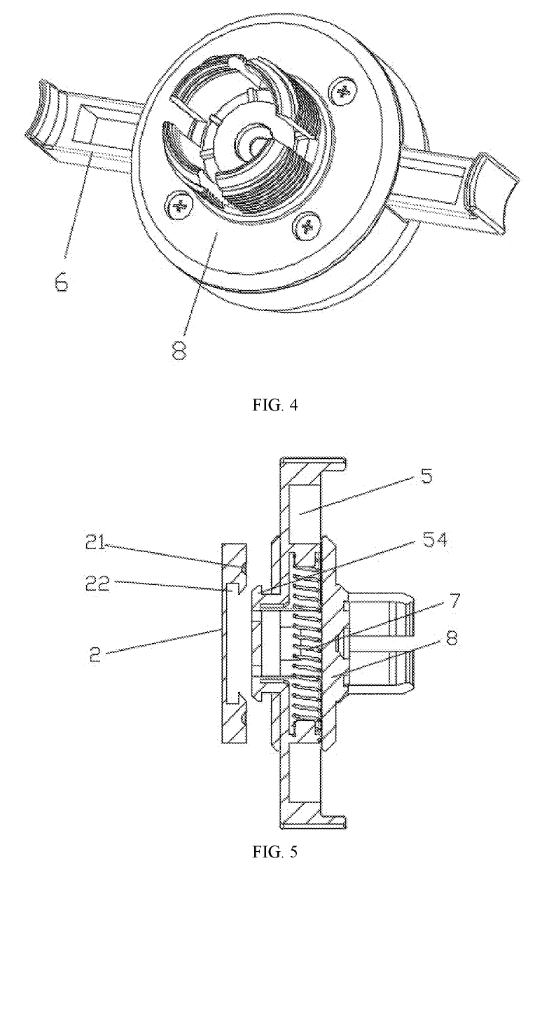

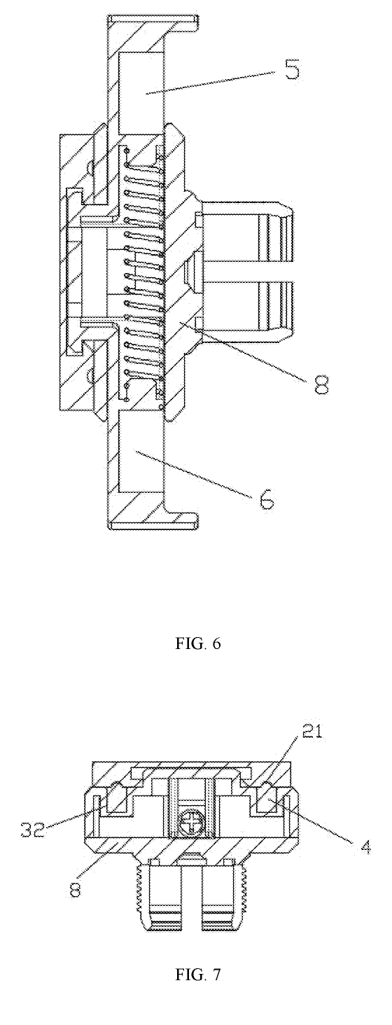

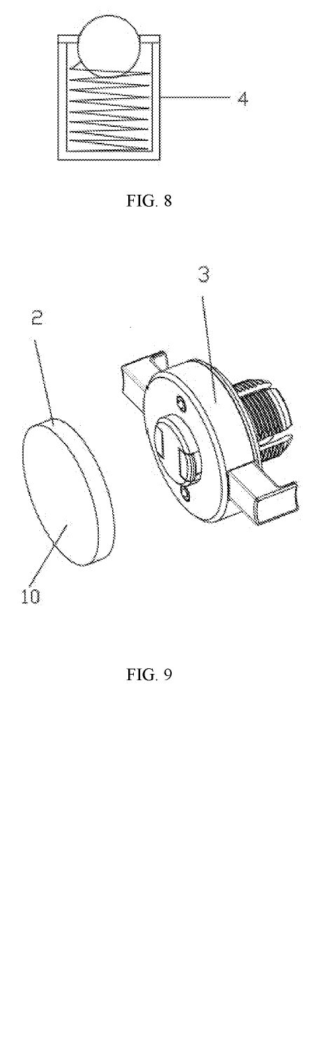

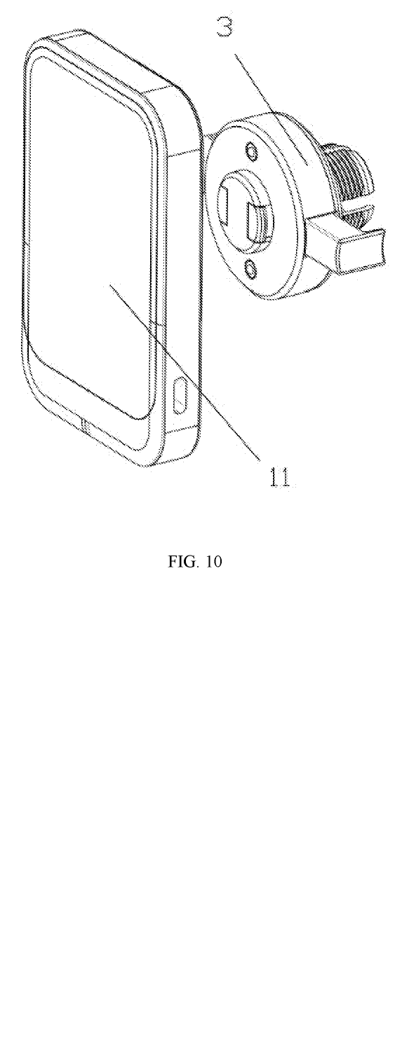

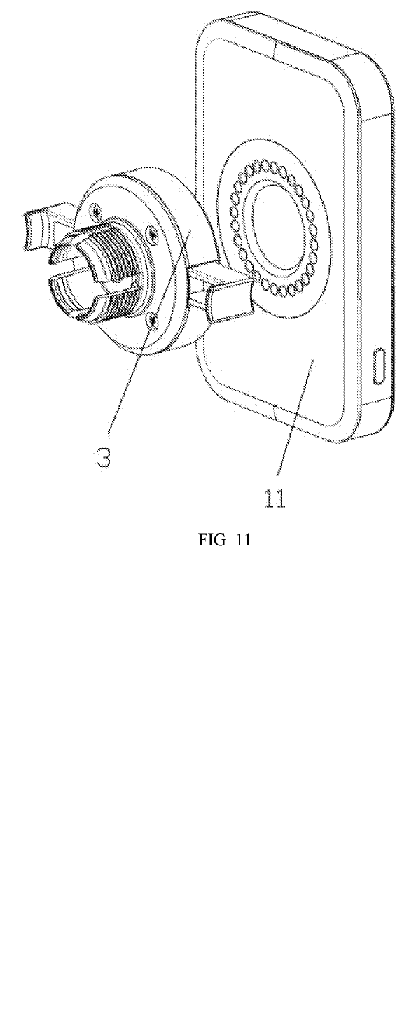

Referring to FIGS. 1-11, a quick-to-dismount holder, including a mobile phone housing 1 or a power bank housing 11 or an adhesive connecting accessory, where a rear end of the mobile phone housing 1 or the power bank housing 11 or the adhesive connecting accessory is provided with a groove (not shown in figures), a connecting member 2 is fixedly mounted in the groove, and a rear end of the connecting member 2 is provided with a detachable structure.

The adhesive connecting accessory is arranged as an adhesive plate, and the adhesive plate can be stuck to a mobile phone or a power bank.

The detachable structure includes a surface cover 3 and a bottom cover 8, where a right arm 5 and a left arm 6 are arranged on the surface cover 3, and a compression spring 7 is arranged between the left arm 6 and the right arm 5. A retaining latch groove 22 is formed in a middle of the connecting member 2, the retaining latch groove 22 is annular, retaining latches 54 are arranged at opposite ends of the right arm 5 and the left arm 6, and the retaining latches 54 are connected to the retaining latch groove 22. The compression spring 7 is linked with the right arm 5 and the left arm 6 to keep the right arm 5 and the left arm 6 in an outward supporting state all the time and ensure that the retaining latches 54 are always kept in a locked state with the retaining latch groove 22.

The connecting member 2 is provided with the retaining latch groove 22 with an oblique guide angle, the retaining latch groove 22 matches the retaining latches 54, the left arm 6 and the right arm 5 are moved to make the compression spring 7 move inward and be compressed, and when the retaining latches 54 reach a middle position of the retaining latch groove 22, the compression spring 7 resets the retaining latches 54 to realize the locked state, such that a function of assembly with one press is realized.

A rotary positioning mechanism is arranged between the connecting member 2 and the surface cover 3.

The rotary positioning mechanism includes ball detent springs 4, where the ball detent springs 4 are fixedly arranged on the surface cover 3, positioning grooves 21 are formed in a circumference of the connecting member 2, and the ball detent springs 4 are connected to the positioning grooves 21.

The rear end of the mobile phone housing 1 or the power bank housing 11 or the adhesive connecting accessory is flush with the rear end of the connecting member 2, a front end of the surface cover 3 is provided with mounting grooves 32, and the ball detent springs 4 are fixedly mounted inside the mounting grooves 32.

Guide grooves 31 are opened in two sides of a rear end of the surface cover 3, the right arm 5 is arranged on an inner wall of the guide groove 31 on a right side, the left arm 6 is arranged on an inner wall of the guide groove 31 on a left side, and the retaining latches 54 extend into a through hole in a center of the surface cover 3.

A side, closest to the compression spring 7, of the right arm 5 is provided with a spring placing groove 51, a spring positioning pin 52 is arranged on an inner wall of the spring placing groove 51, the spring positioning pin 52 is connected to the compression spring 7, a button 53 is arranged on a side, farthest away from the compression spring 7, of the right arm 5, and the left arm 6 and the right arm 5 have the same structure.

The buttons 53 are pressed to make the compression spring 7 be compressed, such that the retaining latches 54 of the right arm 5 and the left arm 6 are released to move inward together to reach retreat positions, and then, an accessory is taken out, thereby realizing a quick taking function with one press. After the right arm 5 and the left arm 6 are released, the compression spring 7 enables the retaining latches 54 of the right arm 5 and the left arm 6 released at the two sides to move outward together and restore to a locked state so as to prepare for mounting an accessory next time.

A circumference of the bottom cover 8 is fixedly connected to the surface cover 3 through screws 9.

Each ball detent spring 4 is formed by a cylindrical housing, a spring and a detent ball, the spring and the detent ball are mounted inside the cylindrical housing, one end of the spring is connected to the detent ball, the other end of the spring is connected to a bottom of an inner wall of the cylindrical housing, and the spring is in a compressed state.

The springs are arranged inside the ball detent springs, such that the detent balls at heads keep an upward thrust force. The ball detent springs provide an upward force to ensure that the retaining latches 54 of the right arm 5 and the left arm 6 are in tight fit with the retaining latch groove in the connecting member 2.

The detent balls at the heads of the ball detent springs 4 correspond to the positioning grooves 21, such that the connecting member 2 can realize 360-degree rotation, and an angle can be kept.

A 3M adhesive layer 10 is mounted on the connecting member 2, and the 3M adhesive layer 10 is stuck to the mobile phone housing 1 or the power bank housing 11 or the adhesive connecting accessory.

The working principle of the present disclosure is: the quick-to-dismount holder can be used for mobile phones and power banks, and connection is achieved under cooperation of the mobile phone housing or the power bank housing or the adhesive connecting accessory. The buttons 53 are pressed to make the compression spring 7 be compressed, such that the retaining latches 54 of the right arm 5 and the left arm 6 are released to move inward together to reach the retreat positions, and then, the accessory is taken out, thereby realizing the quick taking function with one press. After the right arm 5 and the left arm 6 are released, the compression spring 7 enables the retaining latches 54 of the right arm 5 and the left arm 6 released at the two sides to move outward together and restore to the locked state so as to prepare for mounting an accessory next time. The springs are arranged inside the ball detent springs, such that the detent balls at heads keep an upward thrust force. The ball detent springs provide an upward force to ensure that the retaining latches 54 of the right arm 5 and the left arm 6 are in tight fit with the retaining latch groove in the connecting member 2.

Although the examples of the present disclosure have been illustrated and described, it should be understood that those of ordinary skill in the art may make various changes, modifications, replacements and variations to these examples without departing from the principle and purpose of the present disclosure, and the scope of the present disclosure is limited by the appended claims and their legal equivalents.

What is claimed is:

1. A quick-to-dismount holder, comprising a mobile phone housing or a power bank housing or an adhesive connecting accessory, wherein a rear end of the mobile phone housing or the power bank housing or the adhesive connecting accessory is provided with a groove, a connecting member is fixedly mounted in the groove, and a rear end of the connecting member is provided with a detachable structure;
the detachable structure comprises a surface cover and a bottom cover, wherein a right arm and a left arm are arranged on the surface cover, a compression spring is arranged between the left arm and the right arm, a retaining latch groove is formed in a middle of the connecting member, the retaining latch groove is annular, retaining latches are arranged at opposite ends of the right arm and the left arm, and the retaining latches are connected to the retaining latch groove;
a rotary positioning mechanism is arranged between the connecting member and the surface cover; and
the rotary positioning mechanism comprises ball detent springs, wherein the ball detent springs are fixedly arranged on the surface cover, positioning grooves are formed in a circumference of the connecting member, and the ball detent springs are connected to the positioning grooves.

2. The quick-to-dismount holder according to claim 1, wherein the rear end of the mobile phone housing or the power bank housing or the adhesive connecting accessory is flush with the rear end of the connecting member, a front end of the surface cover is provided with mounting grooves, and the ball detent springs are fixedly mounted inside the mounting grooves.

3. The quick-to-dismount holder according to claim 1, wherein guide grooves are opened in two sides of a rear end of the surface cover, the right arm is arranged on an inner wall of the guide groove on a right side, the left arm is arranged on an inner wall of the guide groove on a left side, and the retaining latches extend into a through hole in a center of the surface cover.

4. The quick-to-dismount holder according to claim 3, wherein a side, closest to the compression spring, of the right arm is provided with a spring placing groove, a spring positioning pin is arranged on an inner wall of the spring placing groove, the spring positioning pin is connected to the compression spring, a button is arranged on a side, farthest away from the compression spring, of the right arm, and the left arm and the right arm have the same structure.

5. The quick-to-dismount holder according to claim 1, wherein a circumference of the bottom cover is fixedly connected to the surface cover through screws.

6. The quick-to-dismount holder according to claim 1, wherein each ball detent spring is formed by a cylindrical housing, a spring and a detent ball, the spring and the detent ball are mounted inside the cylindrical housing, one end of the spring is connected to the detent ball, the other end of the spring is connected to a bottom of an inner wall of the cylindrical housing, and the spring is in a compressed state.

7. The quick-to-dismount holder according to claim 1, wherein a 3M adhesive layer is mounted on the connecting member, and the 3M adhesive layer is stuck to the mobile phone housing or the power bank housing or the adhesive connecting accessory.
